(19) United States
(12) Patent Application Publication
(10) Pub. No.: US 2017/0219943 A1
(43) Pub. Date: Aug. 3, 2017

(54) ELECTROPHOTOGRAPHIC IMAGE SUPPORT

(71) Applicant: Konica Minolta, Inc., Tokyo (JP)

(72) Inventors: Toyoko SHIBATA, Zama-shi (JP); Tomoko SAKIMURA, Tokyo (JP); Masanori YUMITA, Tokyo (JP)

(21) Appl. No.: 15/414,867

(22) Filed: Jan. 25, 2017

(30) Foreign Application Priority Data
Jan. 28, 2016 (JP) 2016-014597

(51) Int. Cl. G03G 15/00

(52) U.S. Cl. CPC G03G 5/043

(57) ABSTRACT

An electrophotographic image support includes: a conductive support; a photosensitive layer disposed on the conductive support; and a protective layer disposed on the photosensitive layer, the protective layer being formed of a polymerized cured product of a radically polymerizable composition containing a radically polymerizable monomer and a perfluoropolyether compound having a radically polymerizable functional group, the perfluoropolyether compound having the radically polymerizable functional group being represented by the following formula (1):

[Chemical Formula 1]

(B)ₗ-A-CF₂O(CF₂CF₂O)ₘ(CF₂O)ₙCF₂-A-(B)ₗ (1)

wherein A represents a linking group having a molecular weight of 100 or more and 400 or less, B represents a radically polymerizable functional group, l represents an integer of 2 or more, and m and n each represent an integer of 0 or more, wherein m+n≧1.

The entire disclosure of Japanese Patent Application No. 2016-014597 filed on Jan. 28, 2016 including description, claims, drawings, and abstract are incorporated herein by reference in its entirety.

### BACKGROUND OF THE INVENTION

Field of the Invention

The present invention relates to an electrophotographic image support.

Description of the Related Art

In recent years, with an increasing demand for high-definition and high-quality images, toners having smaller particle sizes have been mainly used for an electrophotographic image forming device. A toner having a small particle size has high adhesion to the surface of an electrophotographic image support (hereinafter also referred to as “image support”). Therefore, in order to achieve high cleanability, when an image support is used, a lubricant is applied thereto. However, in the production printer market where high definition is required, the application of a lubricant has been problematic in that the lubricant causes image quality deterioration.

In order to reduce the adhesion between an image support and a toner and improve the cleanability, the addition of a fluorine-based material, such as fluorine-based fine particles or a fluorine-based lubricant, to a surface layer (also referred to as “protective layer”) has been proposed. However, because of its high surface orientation, a fluorine-based material tends to be present at a high concentration near the surface of the image support. Therefore, although such an image support has high lubricity in the beginning of use, as the surface is worn by repeated use, the high lubricity decreases, and the lubricity is likely to be insufficient.

As a technology for improving both the wear resistance and cleanability of an image support, for example, in a protective layer, a protective layer formed of a polymerized cured product of a radically polymerizable composition containing a urethane acrylate having a perfluoropolyether moiety, a tri- or higher functional radically polymerizable monomer, and a radically polymerizable compound having a charge-transporting structure is known. The molecular weight of the organic group that binds between the perfluoropolyether moiety in the urethane acrylate and the radically polymerizable functional group is 450 or more (see, e.g., JP 2012-128324 A).

In addition, as a technology for maintaining both the toner release properties and low-friction properties of the surface even after printing a large quantity, for example, a protective layer containing perfluoropolyether, wherein the ratio of the number of fluorine atoms to the number of carbon atoms is 0.10 or more and 0.40 or less, is known. The valence of the radically polymerizable monomer containing perfluoropolyether (the number of radically polymerizable functional groups) is 2 (see, e.g., JP 2015-028613 A).

However, even in the protective layer containing a perfluoropolyether compound described above, when the content of the perfluoropolyether compound is high, the wear resistance decreases, while when the content of the perfluoropolyether compound is low, the cleanability after repeated endurance may be insufficient. In addition, although a protective layer is generally formed by the application of a coating material containing a radically polymerizable monomer, followed by a radical polymerization reaction, when the valence of the radically polymerizable functional group of the radically polymerizable compound in the coating material is low, the film-forming properties at the time of protective layer formation maybe insufficient. Like this, in the conventional image supports described above, there still is room for examination in terms of achieving both wear resistance and high-cleanability maintenance.

### SUMMARY OF THE INVENTION

An object of the present invention is to provide an image support having sufficient cleanability even when a protective layer has been worn, regardless of using a lubricant to be applied to the image support.

To achieve the abovementioned object, according to an aspect, an electrophotographic image support reflecting one aspect of the present invention comprises: a conductive support; a photosensitive layer disposed on the conductive support; and a protective layer disposed on the photosensitive layer, the protective layer being formed of a polymerized cured product of a radically polymerizable composition containing a radically polymerizable monomer and a perfluoropolyether compound having a radically polymerizable functional group, the perfluoropolyether compound having the radically polymerizable functional group being represented by the following formula (1) wherein A represents a linking group having a molecular weight of 100 or more and 400 or less, B represents a radically polymerizable functional group, l represents an integer of 2 or more, and m and n each represent an integer of 0 or more, wherein m+n≧1.

[Chemical Formula 1]

(B)ₗ-A-CF₂O(CF₂CF₂O)ₘ(CF₂O)ₙCF₂-A-(B)ₗ (1)

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 schematically shows an example of the configuration of an image forming device according to one embodiment of the present invention.

### DESCRIPTION OF THE PREFERRED EMBODIMENTS

Hereinafter, an embodiment of the present invention will be described with reference to the drawings. However, the scope of the invention is not limited to the illustrated examples. The electrophotographic image support (hereinafter sometimes simply referred to as “image support”) according to this embodiment includes a conductive support, a photosensitive layer disposed on the conductive support, and a protective layer disposed on the photosensitive layer.

The conductive support is a member that is capable of supporting the photosensitive layer and has electrical conductivity. Examples of conductive supports include drums and sheets made of a metal, plastic films having a metal foil laminated thereto, plastic films having a film of a conductive substance deposited thereon, metal components and plastic films having a conductive layer formed by applying a coating material made of a conductive substance or of a conductive substance and a binder resin, and paper. Examples of metals include aluminum, copper, chromium, nickel, zinc, and stainless steel, and examples of conductive substances include metal, indium oxide, and tin oxide.

The photosensitive layer is a layer for forming an electrostatic latent image of a desired image on the surface of the image support by exposure to light as described below. The photosensitive layer may be constituted by a single layer or may also be constituted by a plurality of layers laminated. Examples of photosensitive layers include: a single layer containing a charge transport compound and a charge generation compound; and a laminate of a charge transport layer containing a charge transport compound and a charge generation layer containing a charge generation compound.

The protective layer is a layer for protecting the photosensitive layer that is disposed on the photosensitive layer and also constitutes the surface of the image support. The protective layer is formed of a polymerized cured product of a radically polymerizable composition containing a radically polymerizable monomer and a perfluoropolyether compound having a radically polymerizable functional group. That is, the protective layer is constituted by an integrated polymer obtained by the radical polymerization of the radically polymerizable monomer and contains a perfluoropolyether compound dispersed in the protective layer. The perfluoropolyether compound is bound to the polymer via a covalent bond formed by radical polymerization.

In addition, within a range where the effect according to this embodiment can be obtained, the image support may further contain other structures in addition to the conductive support and the photosensitive layer. Examples of other structures include an intermediate layer. The intermediate layer is a layer that is disposed between the conductive support and the photosensitive layer and has a barrier function and an adhesion function, for example.

The image support may be configured in the same manner as known organic photoreceptors, except for the protective layer constituting its surface. For example, the configuration may be the same as the image support described in JP 2012-078620 A, except for the protective layer. In addition, the protective layer may also be configured in the same manner as described in JP 2012-078620 A, except for the difference in materials.

As described above, the protective layer is a polymerized cured product of the radically polymerizable composition, and the radically polymerizable composition contains the radically polymerizable monomer and the perfluoropolyether compound having a radically polymerizable functional group. They may each be a single kind, or may also be two or more kinds.

In terms of obtaining high film strength, the layered structure of the protective layer is constituted mainly by a cured resin. It is preferable that the cured resin is a resin obtained by the polymerization reaction (curing) of a cross-linkable, polymerizable compound, specifically a compound having two or more radically polymerizable functional groups (e.g., the radically polymerizable monomer described above, etc.), by irradiation with active rays, such as ultraviolet irradiation or electron beam irradiation.

[Radically Polymerizable Monomer]

The radically polymerizable monomer is a compound having a radically polymerizable functional group, which is radically polymerized (cured) by irradiation with active rays such as a ultraviolet irradiation, visible irradiation, or electron beam irradiation, or by the application of energy such as heating, thereby forming a resin generally used as a binder resin for an image support. Examples of radically polymerizable monomers include styrene-based monomers, acrylic-based monomers, methacrylic-based monomers, vinyl toluene-based monomers, vinyl acetate-based monomer, and N-vinyl pyrrolidone-based monomers. Examples of binder resins include polystyrene and polyacrylate.

The radically polymerizable functional group is, for example, a radically polymerizable group having a carbon-carbon double bond. It is particularly preferable that the radically polymerizable functional group is an acryloyl group (CH₂═CHCO—) or a methacryloyl group (CH₂═C(CH₃)CO—) for the reason that curing can be achieved with a small quantity of light or within a short period of time.

Examples of radically polymerizable monomers include the following compounds M1 to M11. In the following formulae, R represents an acryloyl group, and R′ represents a methacryloyl group.

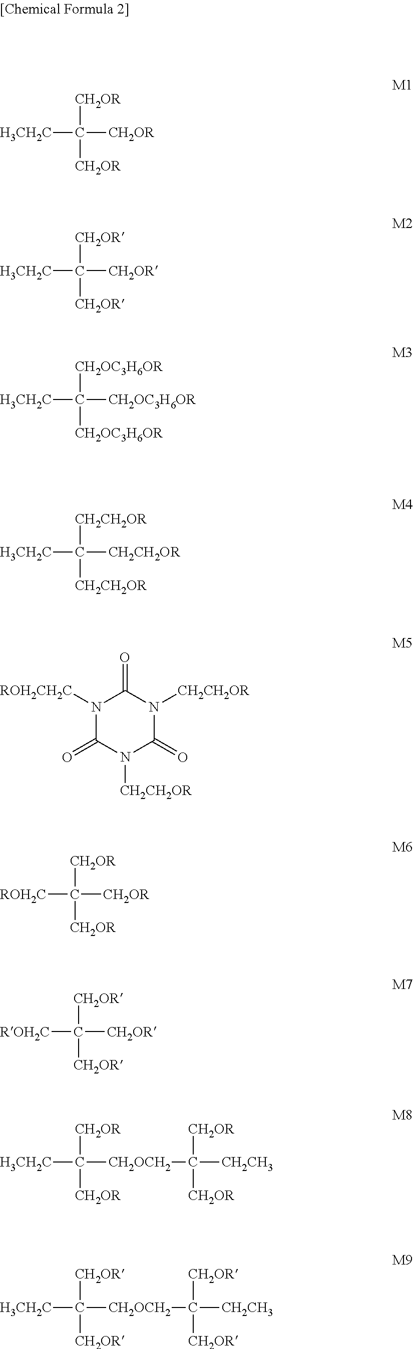

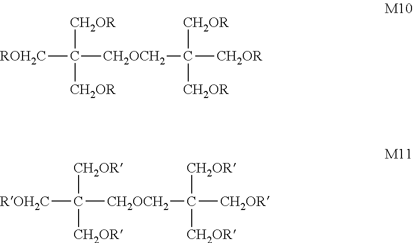

These radically polymerizable monomer compounds are known, and they can also be obtained as commercially available products. In terms of forming a high-hardness protective layer having a high crosslinking density, it is preferable that the radically polymerizable monomer is a compound having three or more radically polymerizable functional groups.

[Perfluoropolyether Compound Having Radically Polymerizable Functional Group]

The perfluoropolyether compound having a radically polymerizable functional group (hereinafter also referred to as “radically polymerizable PFPE”) is represented by the following formula (1).

[Chemical Formula 3]

(B)ₗ-A-CF₂O(CF₂CF₂O)ₘ(CF₂O)ₙCF₂-A-(B)ₗ (1)

The perfluoropolyether (hereinafter also referred to as “PFPE”) in the radically polymerizable PFPE is a compound represented by formula (1) with A and B being removed.

The PFPE is an oligomer or polymer having a perfluoroalkylene ether as a repeating unit. Examples of structures of perfluoroalkylene ether repeating units include structures of perfluoromethylene ether, perfluoroethylene ether, and perfluoropropylene ether repeating units. Among them, it is preferable that that the perfluoropolyether has a repeating structural unit 1 represented by the following formula (a) or a repeating structural unit 2 represented by the following formula (b).

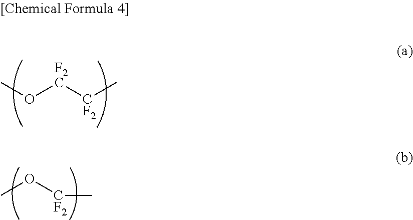

In the case where the PFPE has the repeating structural unit 1 or the repeating structural unit 2, the number m of repeating structural units 1 and the number n of repeating structural units 2 are each an integer of 0 or more, wherein m+n≧1. The m is preferably 4 to 20, and more preferably 7 to 15. In addition, the n is preferably 20 to 4, and more preferably 4 to 7.

In addition, in the case where the PFPE has both the repeating structural unit 1 and the repeating structural unit 2, the repeating structural unit 1 and the repeating structural unit 2 may form a block copolymer structure, or may also form a random copolymer structure.

The weight average molecular weight Mw of the PFPE is preferably 100 or more and 8,000 or less, and more preferably 500 or more and 5000 or less. The Mw can be determined by a known method of utilizing gel permeation chromatography (GPC), for example.

In the above formula (1), A independently represents a linking group having a molecular weight of 100 or more and 400 or less. When the molecular weight of A is 100 or more and 400 or less, the radically polymerizable PFPE has sufficient compatibility with a radically polymerizable monomer. As a result, the radically polymerizable PFPE can be dispersed well in a coating material for a protective layer, whereby the fluorine compound (PFPE) can be contained over the entire protective layer.

When the molecular weight of A is less than 100, the compatibility may be insufficient, whereby the coating film is repelled, making it impossible to obtain a coating film layer of the coating material. In addition, when the molecular weight of A is more than 400, the PFPE proportion in the radically polymerizable PFPE is small. As a result, the fluorine content in the protective layer may be insufficient, making the maintenance of the lubricity of the protective layer insufficient. In addition, when the molecular weight of A is more than 400, the proportion of the linking moiety (A) in the radically polymerizable PFPE is large. As a result, the strength of the protective layer may decrease, making the wear resistance and scratch resistance of the protective layer insufficient.

The molecular weight of the A can be determined, for example, by measuring the molecular weight of the radically polymerizable PFPE by GPC, or by a known method utilizing a known analytical technique, such as combustion ion chromatography.

For example, first, the molecular weight of the radically polymerizable PFPE is measured by GPC. Next, fluorine in the radically polymerizable PFPE is quantified by combustion ion chromatography, and the molecular weight of the PFPE moiety is calculated therefrom. Then, the molecular weight of the PFPE moiety is subtracted from the molecular weight measured by GPC, the resulting difference in molecular weight is divided by the number of functional groups, and further, the molecular weight of the (meth)acryloyl group is subtracted from the resulting quotient, whereby the molecular weight of the linking group A can be determined.

The A should be an organic group having the above molecular weight, and is, for example, a tri- or higher valent organic group containing an ether bond or a urethane bond. In this case, the valence of A alone should be trivalent or higher.

In the above formula (1), B independently represents a radically polymerizable functional group. The radically polymerizable functional group is, for example, a radically polymerizable group having a carbon-carbon double bond, as in the radically polymerizable monomer. The radically polymerizable functional group of the radically polymerizable PFPE may be the same as or different from that of the radically polymerizable monomer. It is particularly preferable that the radically polymerizable functional group to serve as B is represented by the following formula (2), that is, an acryloyloxy group (following formula (B1)) or a methacryloyloxy group (following formula (B2)). Incidentally, in the following formula (2), R represents a hydrogen atom or a methyl group.

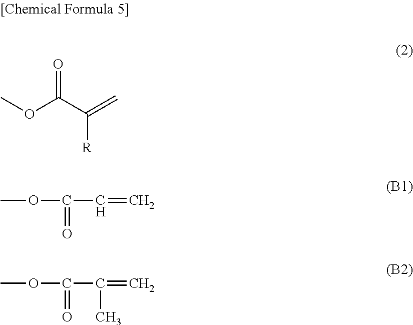

In the above formula (1), l independently represents an integer of 2 or more. That is, the number of radically polymerizable functional groups in the radically polymerizable PFPE is 4 or more. When the number of radically polymerizable functional groups is 4 or more, the protective layer can be provided with sufficient film strength. In addition, in terms of facilitating the synthesis of the radically polymerizable PFPE, it is preferable that that the molecular structure of the radically polymerizable PFPE is symmetrical. From this point of view, it is preferable that the number of radically polymerizable functional groups is an even number. For example, in terms of improving the film strength and also in terms of facilitating the synthesis of the radically polymerizable PFPE, it is more preferable that the number of radically polymerizable functional groups is 6 or more.

The radically polymerizable PFPE can also be suitably synthesized, using a hydroxyl- or carboxyl-terminated PFPE as a raw material, by substituting substituents thereof or by derivation from substituents thereof. Example of synthesis methods for the radically polymerizable PFPE include the following methods.

1) A method in which, using a hydroxyl-terminated PFPE, chloride (meth)acrylate is subjected to an esterification reaction by dehydrochlorination.

2) A method in which, using a hydroxyl-terminated PFPE, an isocyanate compound having a (meth)acryloyl group is subjected to a urethanization reaction.

3) A method in which a carboxyl-terminated PFPE is converted into an acid halide in the usual manner, and, using the acid halide, a compound having a (meth)acryloyl group and a hydroxyl group is subjected to an esterification reaction.

Examples of hydroxyl-terminated PFPEs include Fomblin D2, Fluorolink D4000, Fluorolink E10H, 5158X, 5147X, and Fomblin Z-tet-raol manufactured by Solvay Specialty Polymers, and Demnum-SA manufactured by Daikin Industries, Ltd. Examples of carboxyl-terminated PFPEs include Fomblin ZDIZAC4000 manufactured by Solvay Specialty Polymers and Demnum-SH manufactured by Daikin Industries, Ltd. “FOMBLIN” is a registered trademark of Solvay Specialty Polymers, and “FLUOROLINK” is a registered trademark of Solvay. In addition, “DEMNUM” is a registered trademark of Daikin Industries, Ltd.

Hereinafter, specific examples of synthesis methods for the radically polymerizable PFPE will be shown.

### Synthesis Example 1: Synthesis of Compound P4

20 parts by mass of a PFPE having hydroxyl groups at both terminals represented by the following formula “Fomblin Z-tet-raol” (manufactured by Solvay Specialty Polymers), 0.01 parts by mass of a polymerization inhibitor p-methoxy phenol, 0.01 parts by mass of a urethanization catalyst dibutyltin dilaurate, and 20 parts by mass of methyl ethyl ketone are mixed and stirred in an air stream, and the mixture is heated to 80° C.

Next, 5.7 parts by mass of 2-(acryloyloxy)ethyl isocyanate (molecular weight: 141) is slowly added, with careful attention to heat generation. Next, while stirring the mixture at 80° C., the reaction is carried out for 10 hours. After confirming the disappearance of the absorption peak from an isocyanate group near 2,360 cm⁻¹ by IR spectrum measurement, the solvent is distilled off from the mixture. In this manner, a compound P4, which is a radically polymerizable PFPE, is obtained (yield (e.g.): 25.6 parts by mass).

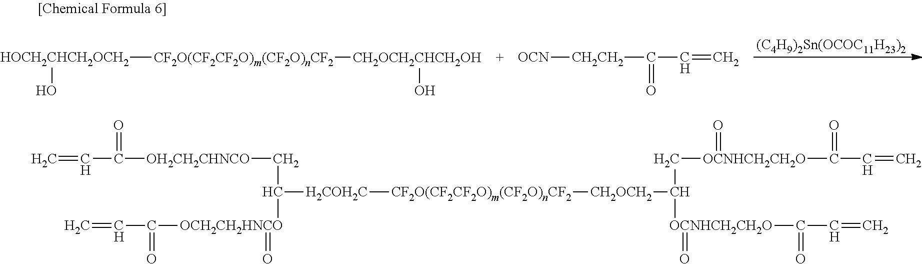

### Synthesis Example 2: Synthesis of Compound P10

10 parts by mass of 2-hydroxy-1,3-dimethacryloxypropane (NK Ester 701 (manufactured by Shin-Nakamura Chemical Co., Ltd.)), 5.8 parts by mass of pyridine, and 40 parts by mass of toluene are mixed and maintained at 6° C. in a nitrogen gas stream, and 6.9 parts by mass of bromine acetyl chloride is slowly added dropwise to the mixture while maintaining the inner temperature at 10° C. or less. After carrying out the reaction for 1 hour while maintaining the inner temperature at 10° C. or less, cooling is stopped to gradually return the temperature to room temperature, and the reaction is carried out for 5 hours at room temperature. The disappearance of the peak from the raw material OH group (δ: 5.8 ppm) is confirmed by ¹H-NMR (300 MHz, DMSO) measurement, thereby giving an intermediate A (yield (e.g.): 12.2 parts by mass).

In a nitrogen gas stream, 1.5 parts by mass of 55% NaH and 30 parts by mass of tetrahydrofuran (THF) are mixed, cooled to 0° C., and stirred for 10 minutes. 20 parts by mass of a PFPE having hydroxyl groups at both terminals “Fomblin D2” (manufactured by Solvay Specialty Polymers) represented by the following formula is added to the mixture. The obtained mixture is returned to room temperature and stirred for 45 minutes. 11 parts by mass of the previously synthesized intermediate A and 0.01 parts by mass of a polymerization inhibitor p-methoxy phenol are added to the mixture and allowed to react for 12 hours at room temperature, thereby giving a compound P10, which is a radically polymerizable PFPE, (yield (e.g.): 18 parts by mass).

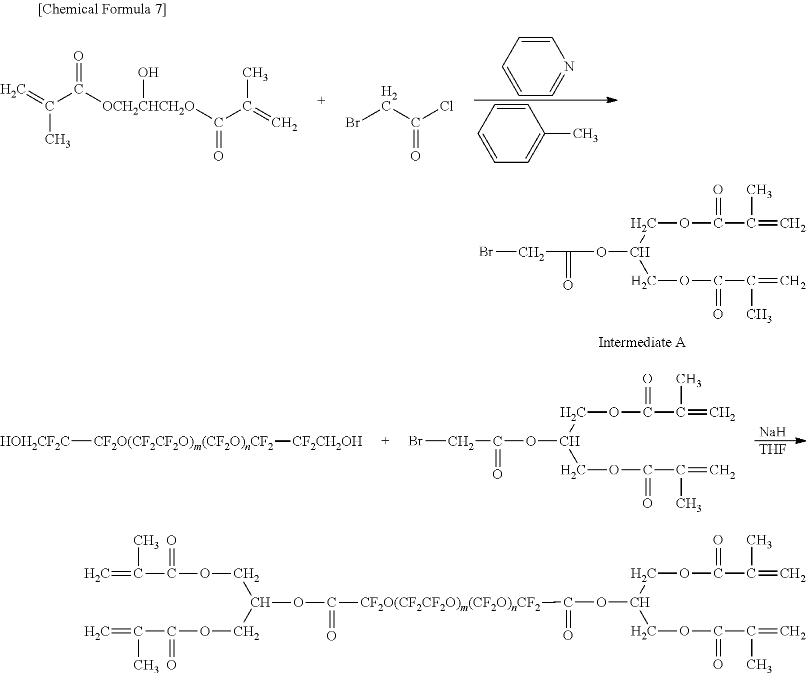

### Synthesis Example 3: Synthesis of Compound P18

The synthesis is performed in the same manner as in Synthesis Example 2, except that 2-hydroxy-1,3-dimethacryloxypropane is replaced with pentaerythritol triacrylate (SR444 (manufactured by Sartomer)) (see the following formula). In this manner, a compound P18, which is a radically polymerizable PFPE, is obtained (yield (e.g.) 22 parts by mass).

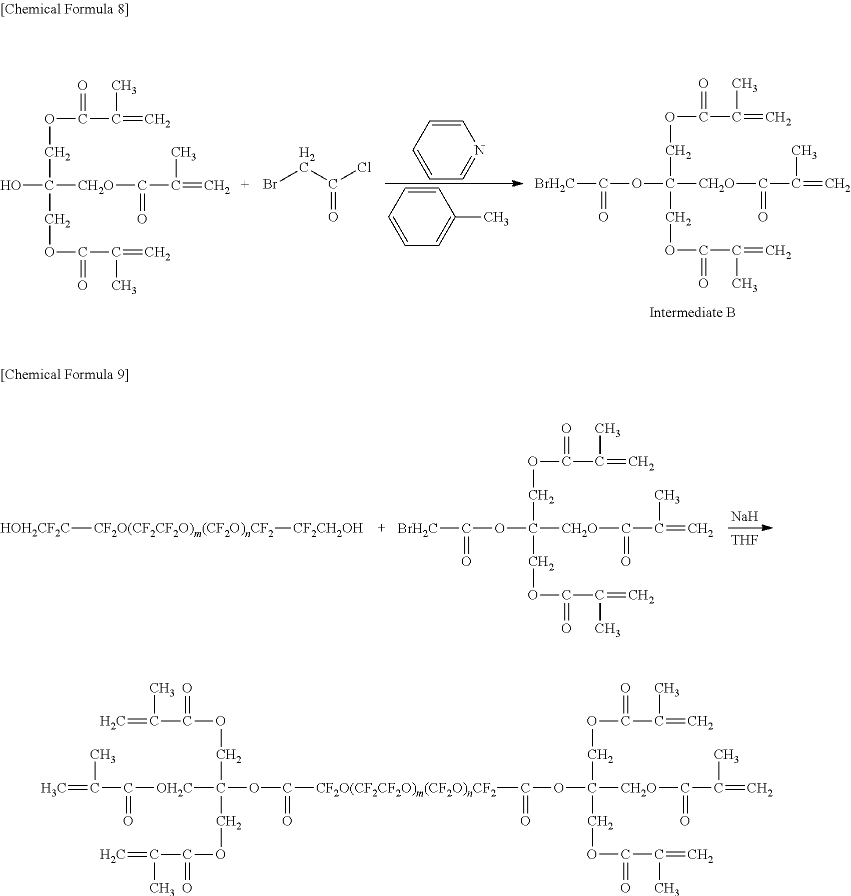

When the content of the radically polymerizable PFPE in the radically polymerizable composition is too low, the cleanability of the image support may be insufficient, while when the content is too high, the wear resistance and scratch resistance of the image support may be insufficient. In terms of sufficiently developing cleanability, it is preferable that the content of the radically polymerizable PFPE in the radically polymerizable composition is 10 parts by mass or more, more preferably 15 parts by mass or more, based on 100 parts by mass of the radically polymerizable monomer. In addition, in terms of sufficiently developing wear resistance and scratch resistance, the content is preferably 100 parts by mass or less, and more preferably 60 parts by mass or less.

Within a range where the effect of this embodiment can be obtained, the radically polymerizable composition may further contain other components other than the radically polymerizable composition. Examples of other components include metal oxide fine particles having a radically polymerizable functional group, solvents, and polymerization initiators.

The metal oxide fine particles having a radically polymerizable functional group described above (hereinafter also referred to as “radically polymerizable metal oxide fine particles”) are metal oxide fine particles carrying on the surface thereof a component having a radically polymerizable functional group. The carrying of the component having a radically polymerizable functional group on the surface of metal oxide fine particles may be physical carrying or may also be chemical binding. The radically polymerizable functional group may be a single kind, or may also be two or more kinds, and they may be the same or different.

The radically polymerizable metal oxide fine particles include, for example, metal oxide fine particles, a surface treatment agent residue chemically bound to the surface thereof, and the radically polymerizable functional group contained in the surface treatment agent residue. In the protective layer, the metal oxide fine particles are present in the state of being chemically bound, via the surface treatment agent residue on the surface thereof, to the integrated polymer constituting the protective layer. Incidentally, the surface treatment agent residue is, for example, a molecular structure chemically bound to the surface of metal oxide fine particles, and is a moiety derived from the surface treatment agent.

Metals in the metal oxide fine particles also include transition metals. The metal oxide fine particles may be a single kind, or may also be two or more kinds, and they may be the same or different. Examples of metal oxides in the metal oxide fine particles include silica (silicon oxide), magnesium oxide, zinc oxide, lead oxide, alumina (aluminum oxide), tin oxide, tantalum oxide, indium oxide, bismuth oxide, yttrium oxide, cobalt oxide, copper oxide, manganese oxide, selenium oxide, iron oxide, zirconium oxide, germanium oxide, tin oxide, titanium dioxide, niobium oxide, molybdenum oxide, vanadium oxide, and copper aluminum oxide. Among them, alumina (Al₂O₃), tin oxide (SnO₂), titanium dioxide (TiO₂), and copper-aluminum composite oxide (CuAlO₂) are preferable.

It is preferable that the number average primary particle size of the metal oxide fine particles is within a range of 1 to 300 nm, particularly preferably 3 to 100 nm. The number average primary particle size of the metal oxide fine particles may be a catalog value, or may also be determined as follows. That is, an enlarged photograph at 10,000× magnification taken by a scanning electron microscope (manufactured by JEOL Ltd.) is incorporated into a scanner. From the obtained photographic image, 300 particle images excluding agglomerated particles are binarized at random using an automatic image processing/analysis system “LUZEX AP” (manufactured by Nireco Corporation; “LUZEX” is their registered trademark, Software Ver. 1.32) to calculate the horizontal Feret diameter of each particle image, and the average is calculated as the number average primary particle sizes. Here, the horizontal Feret diameter refers to the length of the side parallel to the x-axis of the circumscribed rectangle of a binarized particle image.

The carrying of the component having a radically polymerizable functional group on the surface of metal oxide fine particles may be performed by a known technology for surface-treating metal oxide fine particles. For example, the carrying can be performed by a known method for surface-treating metal oxide fine particles with a surface treatment agent, such as the method described in JP 2012-078620 A.

The surface treatment agent has a radically polymerizable functional group and a surface treatment group. The surface treatment agent may be a single kind, or may also be two or more kinds. The surface treatment group is a functional group that is reactive to polar groups, such as hydroxyl groups present on the surface of metal oxide fine particles. The radically polymerizable functional group is, for example, a radically polymerizable group having a carbon-carbon double bond, as in the radically polymerizable monomer or the radically polymerizable PFPE. Examples thereof include a vinyl group, an acryloyl(oxy) group, and a methacryloyl(oxy) group.

As the surface treatment agent, a silane coupling agent having the radically polymerizable functional group is preferable. Examples thereof include the following compounds S-1 to S-31.

S-1: CH₂═CHSi(CH₃) (OCH₃)₂
S-2: CH₂═CHSi(OCH₃)₃
S-3: CH₂═CHSiCl₃
S-4: CH₂═CHCOO(CH₂)₂Si(CH₃) (OCH₃)₂
S-5: CH₂—CHCOO(CH₂)₂Si(OCH₃)₃
S-6: CH₂═CHCOO(CH₂)₂Si(OC₂H₅) (OCH₃)₂
S-7: CH₂═CHCOO(CH₂)₃Si(OCH₃)₃
S-8: CH₂═CHCOO(CH₂)₂Si(CH₃)Cl₂
S-9: CH₂—CHCOO(CH₂)₂SiCl₃
S-10: CH₂═CHCOO(CH₂)₃Si(CH₃)Cl₂
S-11: CH₂—CHCOO(CH₂)₃SiCl₃
S-12: CH₂—C(CH₃)COO(CH₂)₂Si(CH₃) (OCH₃)₂
S-13: CH₂—C(CH₃)COO(CH₂)₂Si(OCH₃)₃
S-14: CH₂—C(CH₃)COO(CH₂)₃Si(CH₃) (OCH₃)₂
S-15: CH₂—C(CH₃)COO(CH₂)₃Si(OCH₃)₃
S-16: CH₂—C(CH₃)COO(CH₂)₂Si(CH₃)Cl₂
S-17: CH₂—C(CH₃)COO(CH₂)₂SiCl₃
S-18: CH₂—C(CH₃)COO(CH₂)₃Si(CH₃)Cl₂
S-19: CH₂—C(CH₃)COO(CH₂)₃SiCl₃
S-20: CH₂═CHSi(C₂H₅)(OCH₃)₂
S-21: CH₂—C(CH₃)Si(OCH₃)₃
S-22: CH₂═C(CH₃)Si(OC₂H₅)₃
S-23: CH₂═CHSi(OCH₃)₃
S-24: CH₂═C(CH₃)Si(CH₃) (OCH₃)₂
S-25: CH₂═CHSi(CH₃)Cl₂
S-26: CH₂═CHCOOSi(OCH₃)₃
S-27: CH₂═CHCOOSi(OC₂H₅)₃
S-28: CH₂═C(CH₃)COOSi(OCH₃)₃
S-29: CH₂═C(CH₃)COOSi(OC₂H₅)₃
S-30: CH₂—C(CH₃)COO(CH₂)₃Si(OC₂H₅)₃
S-31: CH₂═CHCOO(CH₂)₂Si(CH₃)₂ (OCH₃)

When the content of the radically polymerizable metal oxide fine particles in the radically polymerizable composition is too low, the wear resistance and scratch resistance of the image support may be insufficient. In addition, when the content is too high, the PFPE content in the protective layer is relatively low, and, as a result, the cleanability of the image support may be insufficient. In terms of sufficiently developing the mechanical strength of the protective layer and also achieving suitable electrical resistance, it is preferable that the content of the radically polymerizable metal oxide fine particles in the radically polymerizable composition is 30 parts by mass or more based on 100 parts by mass of the total of the radically polymerizable monomer and the radically polymerizable PFPE. In addition, in terms of sufficiently developing cleanability, it is preferable that the content of the radically polymerizable metal oxide fine particles in the radically polymerizable composition is 100 parts by mass or less.

The solvent may be a single kind, or may also be two or more kinds. Examples of solvents include methanol, ethanol, n-propyl alcohol, isopropyl alcohol, n-butanol, t-butanol, sec-butanol, benzyl alcohol, toluene, xylene, methyl ethyl ketone, cyclohexane, ethyl acetate, butyl acetate, methyl cellosolve, ethylcellosolve, tetrahydrofuran, 1,3-dioxane, 1,3-dioxolane, pyridine, and diethylamine.

The polymerization initiator may be a single kind, or may also be two or more kinds. The polymerization initiator may be suitably selected from known polymerization initiators according to the protective layer production process. Examples of polymerization initiators include photopolymerization initiators, thermal polymerization initiators, and polymerization initiators capable of initiating polymerization with both light and heat.

Examples of polymerization initiators include azo compounds, such as 2,2′-azobisisobutyronitrile, 2, 2′-azobis(2, 4-dimethylazobisvaleronitrile), and 2,2′-azobis (2-methyl butyronitrile), and peroxides, such as benzoyl peroxide (BPO), di-tert-butyl hydroperoxide, tert-butyl hydroperoxide, chlorobenzoyl peroxide, dichlorobenzoyl peroxide, bromomethylbenzoyl peroxide, and lauroyl peroxide.

In addition, examples of polymerization initiators also include acetophenone-based and ketal-based photopolymerization initiators, and examples thereof include diethoxyacetophenone, 2,2-dimethoxy-1,2-diphenylethan-1-one, 1-hydroxycyclohexyl phenyl ketone, 4-(2-hydroxyethoxy)phenyl-(2-hydroxy-2-propyl)ketone, 2-benzyl-2-dimethylamino-1-(4-morpholinophenyl)butanone-1 (IRGACURE 369: manufactured by Basf Japan, “IRGACURE” is a registered trademark of BASF A.G.), 2-hydroxy-2-methyl-1-phenylpropan-1-one, 2-methyl-2-morpholino(4-methylthiophenyl)propan-1-one, and 1-phenyl-1,2-propanedione-2-(o-ethoxycarbonyl)oxime.

In addition, examples of polymerization initiators include benzoin ether-based photopolymerization initiators, such as benzoin, benzoin methyl ether, benzoin ethyl ether, benzoin isobutyl ether, and benzoin isopropyl ether, and benzophenone-based photopolymerization initiators, such as benzophenone, 4-hydroxybenzophenone, methyl o-benzoylbenzoate, 2-benzoyl naphthalene, 4-benzoylbiphenyl, 4-benzoylphenyl ether, acrylated benzophenone, and 1,4-benzoylbenzene.

In addition, examples of polymerization initiators include thioxanthone-based photopolymerization initiators such as 2-isopropylthioxanthone, 2-chlorothioxanthone, 2,4-dimethylthioxanthone, 2,4-diethylthioxanthone, and 2,4-dichlorothioxanthone.

In addition, examples of polymerization initiators include ethylanthraquinone, 2,4,6-trimethylbenzoyldiphenyl phosphine oxide, 2,4,6-trimethylbenzoylphenylethoxy phosphine oxide, bis(2,4,6-trimethylbenzoyl)phenyl phosphine oxide, bis(2,4-dimethoxybenzoyl)-2,4,4-trimethylpentyl phosphine oxide, methylphenylglyoxy ester, 9,10-phenanthrene, acridine-based compounds, triazine-based compounds, and imidazole compounds.

In addition, together with the photopolymerization initiator, a photopolymerization promotor having a photopolymerization-promoting effect may also be used. Examples of photopolymerization promotors include triethanolamine, methyldiethanolamine, ethyl 4-dimethylaminobenzoate, isoamyl 4-dimethylaminobenzoate, (2-dimethylamino)ethyl benzoate, and 4,4′-dimethylamino benzophenone.

It is preferable that the polymerization initiator is a photopolymerization initiator. For example, alkylphenone-based compounds and phosphine oxide-based compound are preferable, and polymerization initiators having an α-hydroxy acetophenone structure and polymerization initiators having an acyl phosphine oxide structure are still more preferable.

It is preferable that the content of the polymerization initiator in the radically polymerizable composition is 0.1 to 40 parts by mass, more preferably 0.5 to 20 parts by mass, based on 100 parts by mass of the radically polymerizable monomer.

The image support can be produced by a known method for producing an image support, except for using the above radically polymerizable composition in the coating material for a protective layer. For example, the image support can be produced by a method including a step of applying a coating material for a protective layer containing the radically polymerizable composition to the surface of a photosensitive layer formed on a conductive support, and a step of irradiating the applied coating material for a protective layer with active rays or heating the applied coating material for a protective layer, thereby radically polymerizing the radically polymerizable functional group in the coating material for a protective layer.

In the protective layer, the radically polymerizable monomer and the radically polymerizable PFPE (and the radically polymerizable metal oxide fine particles) constitute an integrated polymerization product (polymerized cured product) forming the protective layer. Whether the polymerized cured product is a polymer of the above radically polymerizable compound can be confirmed by analyzing the polymerized cured product by a known instrumental analysis technology, such as pyrolysis GC-MS, nuclear magnetic resonance (NMR), a Fourier transform infrared spectrometer (FT-IR), or elemental analysis.

The radically polymerizable monomers and the radically polymerizable PFPE each have a radically polymerizable functional group. Therefore, in the radically polymerizable composition, these components have high compatibility with each other. Therefore, the radically polymerizable PFPE is uniformly dispersed in the radically polymerizable composition. As a result, also in the protective layer, the PFPE is present in the state of being uniformly dispersed both in the plane direction and in the thickness direction. In the case where the radically polymerizable composition further contains the radically polymerizable metal oxide fine particles, the effect of excellent dispersibility can also be obtained for the radically polymerizable metal oxide fine particles, as for the radically polymerizable PFPE.

In the protective layer, the radically polymerizable functional groups of the radically polymerizable monomer and the radically polymerizable PFPE (and the radically polymerizable metal oxide fine particles) react with each other, forming a crosslinked structure. Therefore, even when the PFPE content is high to some extent, a high-strength protective layer having sufficient wear resistance can be obtained.

Further, the protective layer maintains high cleanability over a long term. The reasons for this are likely to be as follows. That is, in the protective layer, the PFPE is likely to be present in the state of being uniformly dispersed over the entire protective layer. Like this, in the protective layer, the PFPE is present in the state of being dispersed both in the plane direction and thickness direction of the protective layer. As a result, in the surface of the protective layer, the PFPE is present in an amount sufficient to maintain the high cleanability even when the protective layer is worn.

Then, the protective layer has the above effect even when the application of a lubricant to the image support is minimized or no lubricant is used (i.e., regardless of using a lubricant). The reasons therefor are likely to be as follows.

That is, because the coating material contains the polyfunctional radically polymerizable PFPE having the above molecular weight and having the above linking group, the radically polymerizable PFPE is sufficiently dispersed in the coating material and also in its coating film. As a result, the entire protective layer contains a fluorine compound (PFPE), and also the radically polymerized moiety (cured moiety) of the radically polymerizable composition is contained in a sufficient amount. As a result, presumably, a protective layer also having sufficiently high film strength in addition to the above cleanability can be obtained.

Further, the radically polymerizable PFPE has four or more radically polymerizable functional groups. Therefore, the number of binding sites between the radically polymerizable monomer (and the radically polymerizable metal oxide fine particles) and the PFPE increases. As a result, a protective layer that maintains the high wear resistance and high cleanability as described above can be obtained.

The image support is used as an organic photoreceptor in an electrophotographic image forming device. The image forming device includes, for example: the image support; a charging device for charging the surface of the image support; an exposure device for irradiating the charged surface of the image support with light to form an electrostatic latent image; a developing device for supplying a toner to the image support having formed thereon the electrostatic latent image to forma toner image; a transfer device for transferring a toner image on the surface of the image support to a recording medium; and a cleaning device for removing the toner remaining on the surface of the image support after the toner image has been transferred to the recording medium.

In addition, the image support is applied to an image forming method including: feeding a toner to the surface of the image support having formed thereon an electrostatic latent image to form a toner image corresponding to the electrostatic latent image on the surface of the image support; transferring the toner image from the surface of the image support to a recording medium; and removing the toner remaining on the surface of the image support by a cleaning device. The image forming method is performed by the above image forming device, for example.

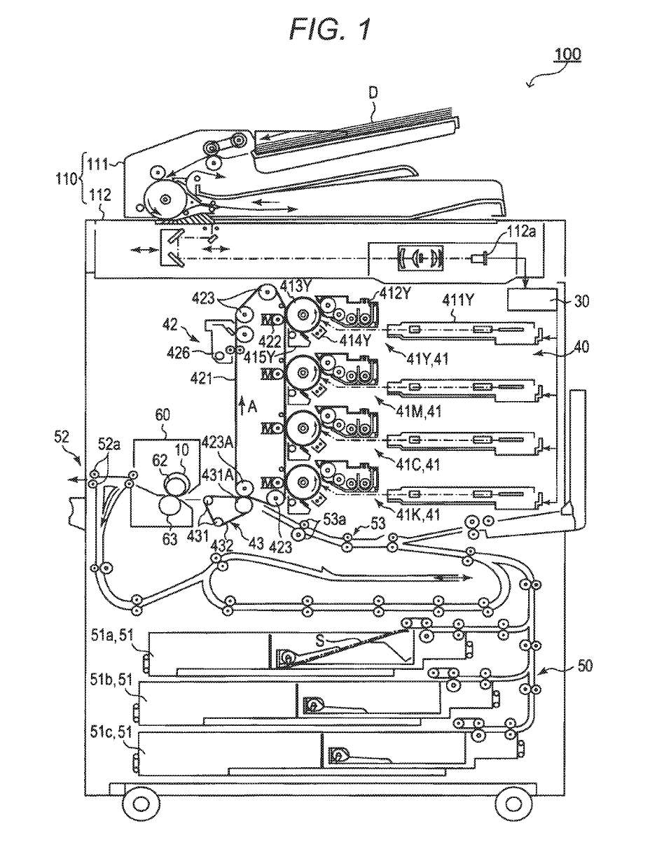

FIG. 1 schematically shows an example of the configuration of an image forming device including the image support described above. The image forming device 100 shown in FIG. 1 includes an image reading section 110, an image processing section 30, an image forming section 40, a paper transport section 50, and a fixing device 60.

The image forming section 40 has image forming units 41Y, 41M, 41C, and 41K that form images with toners of the respective colors Y (yellow), M (magenta), C (cyan), and K (black). They have the same configuration except for the toner to be received, so the symbol indicating the color may be omitted hereinafter. The image forming section 40 has an intermediate transfer unit 42 and a secondary transfer unit 43. They are equivalent to transfer devices.

The image forming unit 41 includes an exposure device 411, a developing device 412, the image support 413 described above, a charging device 414, and a drum cleaning device 415. The charging device 414 is a corona charger, for example. The charging device 414 may also be a contact charging device that brings a contact charging member, such as a charged roller, a charged brush, ora charged blade, to the image support 413 and charge the same. The exposure device 411 includes, for example, a semiconductor laser as a light source and a light deflector (polygon motor) that applies a laser beam corresponding to an image to be formed toward the image support 413.

The developing device 412 is a developing device for two-component development. The developing device 412 includes, for example, a developing container that contains a two-component developer, a developing roller (magnetic roller) rotatably disposed at the opening of the developing container, a partition that partitions the inside of the developing container in such a manner to allow for the passage of the two-component developer, a transport roller for transporting the two-component developer on the opening side of the developing container toward the developing roller, and a stirring roller for stirring the two-component developer in the developing container. The developing container contains, for example, a two-component developer.

In the case where a lubricant is applied to the image support 413, the lubricant is disposed, for example, in the drum cleaning device 415 or between the drum cleaning device 415 and the charging device 414 in such a manner that the lubricant contacts the surface of the image support after transfer. Alternatively, the lubricant may also be fed to the surface of the image support 413 as an external additive of a two-component developer at the time of development.

The intermediate transfer unit 42 includes an intermediate transfer belt 421, a primary transfer roller 422 that presses the intermediate transfer belt 421 against the image support 413, a plurality of support rollers 423 including a backup roller 423A, and a belt cleaning device 426. The intermediate transfer belt 421 is stretched in a loop shape by the plurality of support rollers 423. When at least one driving roller of the plurality of support rollers 423 is rotated, the intermediate transfer belt 421 runs at a constant speed in the direction of the arrow A.

The secondary transfer unit 43 includes an endless secondary transfer belt 432 and a plurality of support rollers 431 including a secondary transfer roller 431A. The secondary transfer belt 432 is stretched in a loop shape by the secondary transfer roller 431A and the support roller 431.

The fixing device 60 includes, for example, a fixing roller 62, an endless heat generation belt 10 that covers the outer peripheral surface of the fixing roller 62 for heating and fusing the toner that constitutes the toner image on the paper S, and a pressure roller 63 that presses the paper S against the fixing roller 62 and the heat generation belt 10. The paper S is equivalent to a recording medium.

The image forming device 100 further includes the image reading section 110, the image processing section 30, and the paper transport section 50. The image reading section 110 includes a paper feeder 111 and a scanner 112. The paper transport section 50 includes a paper feed section 51, a paper ejection section 52, and a transport path section 53. In the three paper feed tray units 51a to 51c constituting the paper feed section 51, the paper S identified based on the basis weight, size, and the like (standard paper, special paper) is stored according to the pre-set kind. The transport path section 53 includes a plurality of transport roller pairs, such as a resist roller pair 53a.

The formation of an image by the image forming device 100 will be described. The scanner 112 optically scans and reads a document Don the contact glass. The reflected light from the document D is read by the CCD sensor 112a as an input image data. The input image data is subjected to predetermined image processing in the image processing section 30 and sent to the exposure device 411.

The image support 413 rotates at a constant peripheral speed. The charging device 414 negatively charges the entire surface of the image support 413. In the exposure device 411, the polygon mirror of the polygon motor rotates at a high speed, and the laser beam corresponding to the input image data of each color component spreads along the axial direction of the image support 413 and is applied to the outer peripheral surface of the image support 413 along the axial direction. In this manner, an electrostatic latent image is formed on the surface of the image support 413.

In the developing device 412, as a result of stirring and transporting the two-component developer in the developing container, toner particles are charged, and the two-component developer is transported to the developing roller and forms a magnetic brush on the surface of the developing roller. The charged toner particles electrostatically adhere from the magnetic brush to the electrostatic latent image portion of the image support 413. In this manner, the electrostatic latent image on the surface of the image support 413 is visualized, and a toner image corresponding to the electrostatic latent image is formed on the surface of the image support 413. Incidentally, “toner image” refers to the state where toner particles are assembled to form an image.

The toner image on the surface of the image support 413 is transferred to the intermediate transfer belt 421 by the intermediate transfer unit 42. The transfer residual toner remaining on the surface of the image support 413 after transfer is removed by the drum cleaning device 415 having a drum cleaning blade that slidably contacts the surface of the image support 413.

In the protective layer of the image support 413, as described above, a sufficient amount of PFPE (and also metal oxide fine particles if further contained) is uniformly dispersed over the entire protective layer integrally constituted by a polymerization product obtained by the radical polymerization of a radically polymerizable monomer. Therefore, the wear resistance and scratch resistance caused by the sufficient hardness of the polymerization product and the high cleanability caused by the PFPE are sufficiently developed.

Therefore, the image support 413 is excellent in wear resistance, scratch resistance, and cleanability even without a lubricant being applied, and these characteristics are developed over a long term. In the case where the radically polymerizable metal oxide fine particles are further contained, the improving effect on mechanical strength caused by the metal oxide fine particles is further obtained. Further, in the case where the image forming device 100 has a lubricant to be applied to the image support 413, the amount of lubricant can be reduced as compared with conventional image forming devices, making it possible to minimize the amount used.

When the primary transfer roller 422 presses the intermediate transfer belt 421 against the image support 413, a primary transfer nip is formed for every image support by the image support 413 and the intermediate transfer belt 421. In the primary transfer nip, toner images of respective colors are successively, overlappingly transferred to the intermediate transfer belt 421.

Meanwhile, the secondary transfer roller 431A is pressed against the backup roller 423A through the intermediate transfer belt 421 and the secondary transfer belt 432. As a result, a secondary transfer nip is formed by the intermediate transfer belt 421 and the secondary transfer belt 432. The paper S passes through the secondary transfer nip. The paper S is transported to the secondary transfer nip by the paper transport section 50. The correction of the inclination of the paper S and the adjustment of the timing of transport are performed by a resist roller section including the resist roller pair 53a.

When the paper S is transported to the secondary transfer nip, a transfer bias is applied to the secondary transfer roller 431A. As a result of the application of the transfer bias, the toner image carried on the intermediate transfer belt 421 is transferred to the paper S. The paper S having transferred thereto the toner image is transported toward the fixing device 60 by the secondary transfer belt 432.

The fixing device 60 forms a fixing nip by the heat generation belt 10 and the pressure roller 63, and the transported paper S is heated and pressurized in the fixing nip section. In this manner, the toner image is fixed to the paper S. The paper S having fixed thereto the toner image is ejected outside the device from the paper ejection section 52 equipped with a paper ejection roller 52a.

Incidentally, the transfer residual toner remaining on the surface of the intermediate transfer belt 421 after secondary transfer is removed by the belt cleaning device 426 having a belt cleaning blade that slidably contacts the surface of the intermediate transfer belt 421.

As described above, the image support 413 is excellent in wear resistance, scratch resistance, and cleanability, and these characteristics are developed over a long term regardless of using a lubricant. Therefore, the image forming device 100 can form an image with desired image quality stably over a long term.

As is clear from the above description, the image support according to this embodiment includes a conductive support, a photosensitive layer disposed on the conductive support, and a protective layer disposed on the photosensitive layer. Then, the protective layer is formed of a polymerized cured product of the radically polymerizable composition containing the radically polymerizable monomer and the radically polymerizable PFPE, and the radically polymerizable PFPE is represented by the above formula (1). Therefore, the image support is excellent in wear resistance, scratch resistance, and cleanability, and these characteristics are developed over a long term. As a result, the image support can develop sufficient cleanability even when a protective layer has been worn, regardless of using a lubricant to be applied to the image support.

In addition, when B in the above formula (1) in the radically polymerizable PFPE is a (meth)acryloyloxy group, the reaction rate is high, whereby the crosslinking density can be enhanced. Thus, this is even more effective in terms of improving the mechanical strength and wear resistance.

In addition, when the radically polymerizable composition further contains the radically polymerizable metal oxide fine particles, this is even more effective in terms of enhancing the mechanical strength of the protective layer.

### EXAMPLES

[Synthesis of Radically Polymerizable PFPEs 1 to 26 (Compounds P1 to P26)]

According to the synthesis method described above, a radically polymerizable PFPE 1 (compound P1) represented by the following formula (1), wherein A is a molecular structure A1 represented by the following formula (a1) (molecular weight: 129.1), B is an acryloyloxy group, and 1 is 2, was synthesized. In formula (a1), the molecular structure A1 is a moiety excluding PFPE and B, and the molecular weight of A1 is 129.1. In addition, in formula (a1), “PFPE” represents “—CF₂O(CF₂CF₂O)ₘ (CF₂O)ₙCF₂—” in formula (1). With respect to the compounds P1 to P5, P10, P11 to P15, and P20 described below, a PFPE represented by formula (1), wherein approximately m=13 and n=7, was used. With respect to the compounds P6 to P9, P16 to P19, and P21 to P26 described below, a PFPE represented by formula (1), wherein approximately m=9 and n=5, was used.

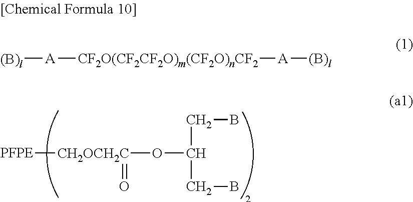

In addition, radically polymerizable PFPEs 2 to 6 (compounds P2 to P6) represented by formula (1), wherein A is one of the molecular structures A2 to A6 represented by the following formulae (a2) to (a6), B is an acryloyloxy group, and l is 2, were each synthesized. The molecular weight of A2 is 128.2, the molecular weight of A3 is 214.2, the molecular weight of A4 is 245.3, the molecular weight of A5 is 302.3, and the molecular weight of A6 is 128.2.

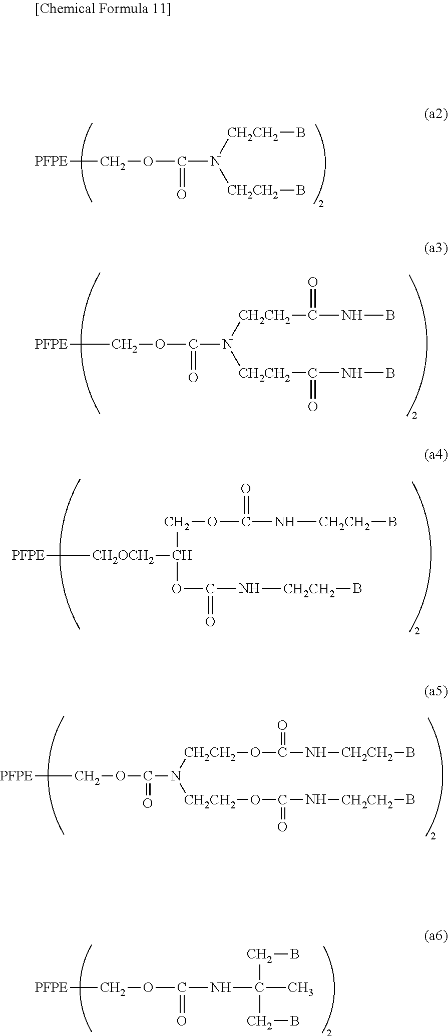

In addition, radically polymerizable PFPEs 7 to 10 (compounds P7 to P10) represented by formula (1), wherein A is one of the molecular structures A7 to A10 represented by the following formulae (a7) to (a10), B is an acryloyloxy group, and l is 3, were each synthesized. The molecular weight of A7 is 127.1, the molecular weight of A8 is 142.2, the molecular weight of A9 is 121.1, and the molecular weight of A10 is 388.4.

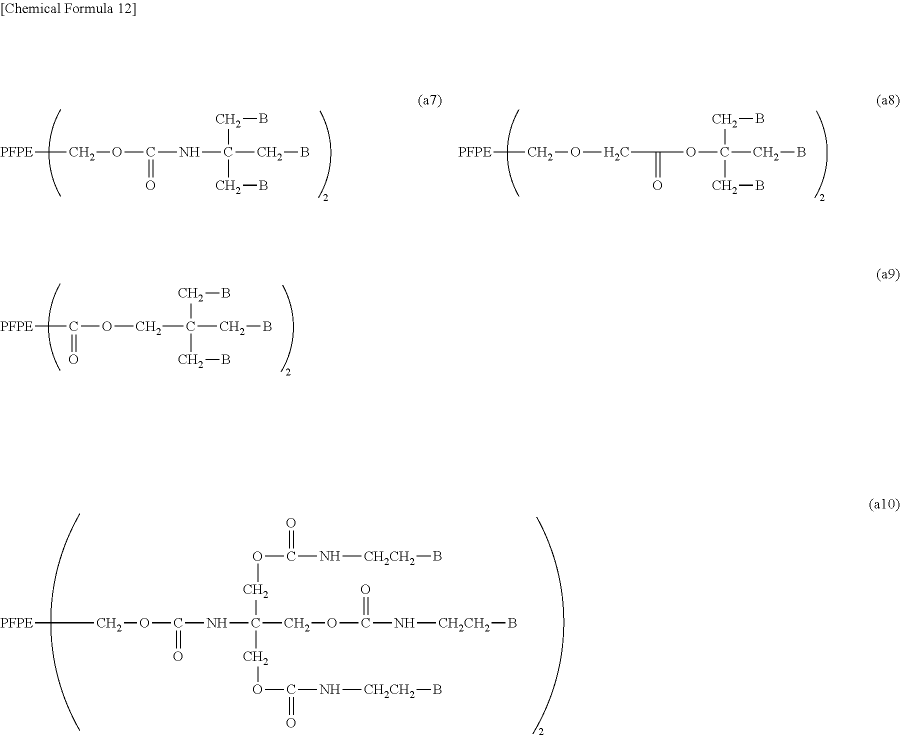

In addition, radically polymerizable PFPEs 11 to 20 (compounds P11 to P20), having the same structures as the compounds P1 to P10, respectively, expect that B was replaced with a methacryloyloxy group, were synthesized.

In addition, radically polymerizable PFPEs 21 to 25 (compounds P21 to P25) represented by formula (1), wherein A is one of the molecular structures A11 to A15 represented by the following formulae (a11) to (a15), B is an acryloyloxy group, and l is 2, were each synthesized. In addition, a radically polymerizable PFPE 26 (compound P26) represented by the following formula (1), wherein A is a molecular structure A16 represented by the following formula (a16), B is an acryloyloxy group, and l is 1, was synthesized. The molecular weight of A21 is 770.1, the molecular weight of A22 is 624.8, the molecular weight of A23 is 469.6, the molecular weight of A24 is 71.1, the molecular weight of A25 is 69.1, and the molecular weight of A26 is 14.0.

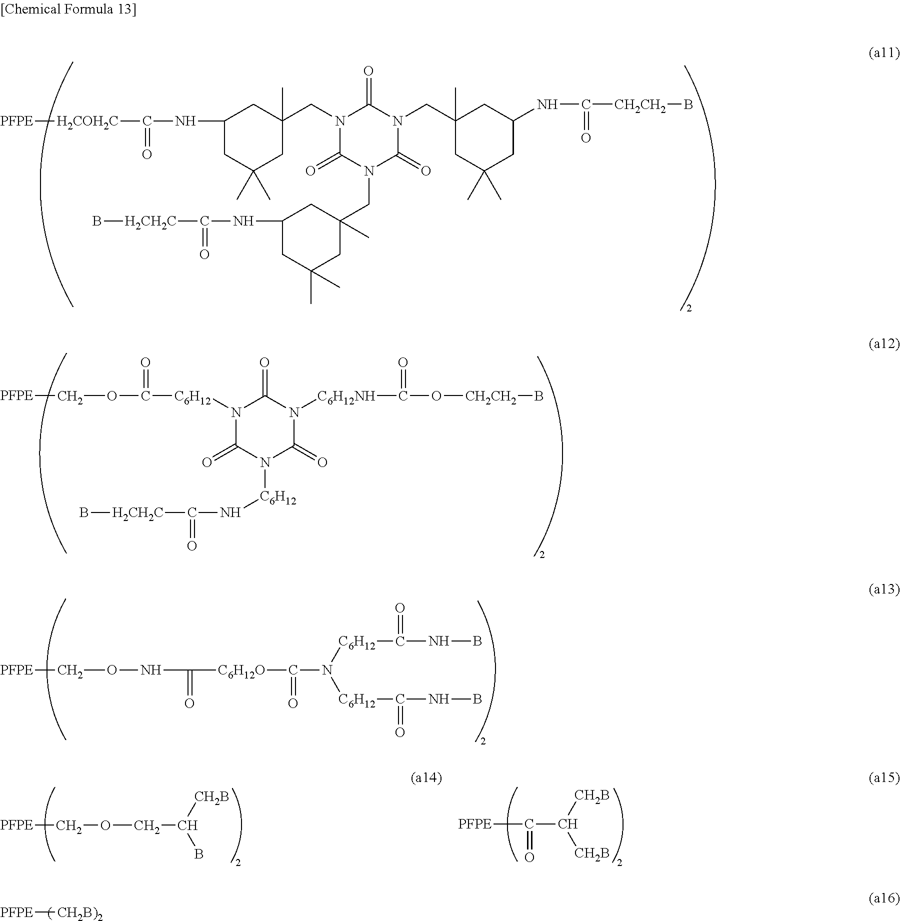

The structures of the compounds P1 to P26 are shown in Table 1. In the tables, “B1” represents an acryloyloxy group and “B2” represents a methacryloyloxy group. In addition, the “number of functional groups” is the number of “B” per molecule in the radically polymerizable PFPE.

TABLE 1

| | |
|---|---|
| A | Number of |

| Compound | | Molecular | | functional |
|---|---|---|---|---|
| No. | Structure | weight | B | groups |
| P1 | A1 | 129.1 | B1 | 4 |
| P2 | A2 | 128.2 | B1 | 4 |
| P3 | A3 | 214.2 | B1 | 4 |
| P4 | A4 | 245.3 | B1 | 4 |
| P5 | A5 | 302.3 | B1 | 4 |
| P6 | A6 | 128.2 | B1 | 4 |
| P7 | A7 | 127.1 | B1 | 6 |
| P8 | A8 | 142.2 | B1 | 6 |
| P9 | A9 | 121.1 | B1 | 6 |
| P10 | A10 | 388.4 | B1 | 6 |
| P11 | A1 | 129.1 | B2 | 4 |
| P12 | A2 | 128.2 | B2 | 4 |
| P13 | A3 | 214.2 | B2 | 4 |
| P14 | A4 | 245.3 | B2 | 4 |
| P15 | A5 | 302.3 | B2 | 4 |
| P16 | A6 | 128.2 | B2 | 4 |
| P17 | A7 | 127.1 | B2 | 6 |
| P18 | A8 | 142.2 | B2 | 6 |
| P19 | A9 | 121.1 | B2 | 6 |
| P20 | A10 | 388.4 | B2 | 6 |
| P21 | A11 | 770.1 | B1 | 6 |
| P22 | A12 | 624.8 | B1 | 6 |
| P23 | A13 | 469.6 | B1 | 4 |
| P24 | A14 | 71.1 | B1 | 4 |
| P25 | A15 | 69.1 | B1 | 4 |
| P26 | A16 | 14.0 | B1 | 2 |

[Production of Metal Oxide Fine Particles 1]

100 parts by mass of tin oxide particles having a number average primary particle size of 20 nm as metal oxide fine particles, 7 parts by mass of “3-methacryloxypropyl trimethoxysilane (S-15)” as a surface treatment agent, and 1000 parts by mass of methyl ethyl ketone were placed in a wet sand mill (media: 0.5-mm-diameter alumina beads) and mixed at 30° C. for 6 hours. Subsequently, methyl ethyl ketone and alumina beads were separated from metal oxide fine particles by filtration, and the metal oxide fine particles were dried at 60° C. In this manner, metal oxide fine particles 1 to serve as the radically polymerizable metal oxide fine particles described above were produced.

[Production of Metal Oxide Fine Particles 2]

Metal oxide fine particles 2 to serve as the radically polymerizable metal oxide fine particles described above were produced in the same manner as in the production of the metal oxide fine particles 1, except that metal oxide fine particles were changed to copper aluminum oxide particles having a number average primary particle size of 50 nm, and the amount of surface treatment agent used was changed to 3.5 parts by mass.

### Example 1: Production of Image Support 1

### (1) Preparation of Conductive Support

The surface of a cylindrical aluminum support was processed by cutting, thereby preparing a conductive support.

### (2) Production of Intermediate Layer

Polyamide resin (X1010, manufactured by Daicel-Degussa Ltd.): 10 parts by mass

Titanium oxide particles (SMT500SAS, manufactured by Tayca Corporation): 11 parts by mass

Ethanol: 200 parts by mass

The above materials for an intermediate layer were mixed and dispersed for 10 hours in a batch process using a sand mill as a dispersing machine, thereby preparing a coating liquid for an intermediate layer. The coating liquid was applied to the surface of the conductive support by a dip coating method and dried at 110° C. for 20 minutes, thereby forming an intermediate layer having a thickness of 2 μm on the conductive support.

### (3) Production of Charge Generation Layer

Charge generation substance (titanylphthalocyanine having clear peaks at 8.3°, 24.7°, 25.1°, and 26.5° in Cu-Kα characteristic X-ray diffraction spectrum measurement and mixed crystals of a 1:1 adduct of (2R,3R)-2,3-butanediol and non-added titanylphthalocyanine): 24 parts by mass

Polyvinyl butyral resin (S-LEC BL-1, manufactured by Sekisui Chemical Co., Ltd.; “S-LEC” is their registered trademark): 12 parts by mass

Liquid mixture (3-methyl-2-butanone/cyclohexanone=4/1 (V/V): 400 parts by mass)

The above materials for a charge generation layer were mixed and dispersed at a circulating flow rate of 40 L/hour for 0.5 hours using a circulation-type ultrasound homogenizer “RUS-600TCVP (manufactured by NISSEI Corporation)” at 19.5 kHz and 600 W, thereby preparing a coating liquid for a charge generation layer. The coating liquid was applied to the surface of the intermediate layer by a dip coating method and dried, thereby forming a charge generation layer having a thickness of 0.3 μm on the intermediate layer.

### (4) Production of Charge Transport Layer

Charge transport substance represented by the following structural formula (2): 60 parts by mass

Polycarbonate resin (Z300, manufactured by Gas Chemical Company, Inc.): 100 parts by mass

Antioxidant (IRGANOX1010, manufactured by BASF; “IRGANOX” is their registered trademark): 4 parts by mass

Toluene/tetrahydrofuran: 800 parts by mass

Silicone oil: 1 parts by mass

The above materials for a charge transport layer were mixed and dissolved, thereby preparing a coating liquid for a charge transport layer. The coating liquid was applied to the surface of the charge generation layer by a dip coating method and dried at 120° C. for 70 minutes, thereby forming a charge transport layer having a thickness of 24 μm on the charge transport layer. Incidentally, the toluene/tetrahydrofuran is a mixed solvent prepared by mixing 9 parts by volume of THF with 1 part by volume of toluene. In addition, the silicone oil is “KF-54” (manufactured by Shin-Etsu Chemical Co., Ltd.).

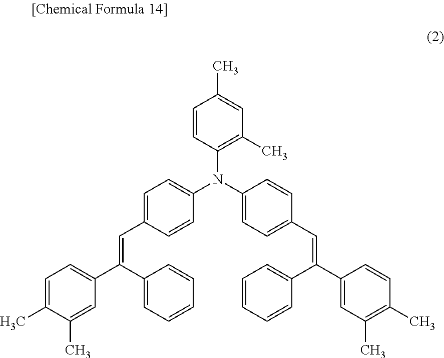

### (5) Production of Protective Layer

Radically polymerizable monomer (M2): 100 parts by mass

Compound P10: 40 parts by mass

Metal oxide fine particles 2: 100 parts by mass

Polymerization initiator: 10 parts by mass

2-buthanol: 400 parts by mass

The above materials for a protective layer were dissolved and dispersed, thereby preparing a coating liquid for a protective layer. The coating liquid was applied to the surface of the charge transport layer using a circular slide hopper coating machine. Incidentally, the polymerization initiator is IRGACURE 819 (manufactured by BASF Japan; “IRGACURE” is the registered trademark of BASF A.G.).

Next, the film of the applied the coating liquid was subjected to ultraviolet irradiation for 1 minute from a metal halide lamp to cure the film, thereby forming a protective layer having a thickness of 3.0 μm on the charge transport layer. In this manner, an image support 1 was produced.

### Example 2: Production of Image Support 2

An image support 2 was produced in the same manner as in the production of the image support 1, except that the radically polymerizable monomer was change from “M2” to “M1”, the radically polymerizable PFPE was changed from “compound P10” to “compound P2”, and the metal oxide fine particles were changed from “2” to “1”.

### Example 3: Production of Image Support 3

An image support 3 was produced in the same manner as in the production of the image support 1, except that the amount of radically polymerizable monomer was changed from “100 parts by mass” to “120 parts by mass”, the radically polymerizable PFPE was changed from “compound P10” to “compound P3”, the amount of radically polymerizable PFPE was changed from “40 parts by mass” to “20 parts by mass”.

### Example 4: Production of Image Support 4

An image support 4 was produced in the same manner as in the production of the image support 1, except that the radically polymerizable monomer was changed from “M2” to “M6”, the amount of radically polymerizable monomer was changed from “100 parts by mass” to “110 parts by mass”, the radically polymerizable PFPE was changed from “compound P10” to “compound P13”, the amount of radically polymerizable PFPE was changed from “40 parts by mass” to “30 parts by mass”, and the amount of metal oxide fine particles was changed from “100 parts by mass” to “120 parts by mass”.

### Example 5: Production of Image Support 5

An image support 5 was produced in the same manner as in the production of the image support 1, except that the radically polymerizable monomer was changed from “M2” to “M1”, the amount of radically polymerizable monomer was changed from “100 parts by mass” to “120 parts by mass”, the radically polymerizable PFPE was changed from “compound P10” to “compound P14”, and the amount of radically polymerizable PFPE was changed from “40 parts by mass” to “20 parts by mass”.

### Example 6: Production of Image Support 6

An image support 6 was produced in the same manner as in the production of the image support 5, except that the amount of radically polymerizable monomer was changed from “120 parts by mass” to “90 parts by mass”, the radically polymerizable PFPE was changed from “compound P14” to “compound P6”, the amount of radically polymerizable PFPE was changed from “20 parts by mass” to “50 parts by mass”, and the metal oxide fine particles were changed from “2” to “1”.

### Example 7: Production of Image Support 7

An image support 7 was produced in the same manner as in the production of the image support 5, except that the amount of radically polymerizable monomer was changed from “120 parts by mass” to “100 parts by mass”, the radically polymerizable PFPE was changed from “compound P14” to “compound P7”, the amount of radically polymerizable PFPE was changed from “20 parts by mass” to “40 parts by mass”, the metal oxide fine particles changed from “2” to “1”, and the amount of metal oxide fine particles was changed from “100 parts by mass” to “120 parts by mass”.

### Example 8: Production of Image Support 8

An image support 8 was produced in the same manner as in the production of the image support 5, except that the amount of radically polymerizable monomer was changed from “120 parts by mass” to “100 parts by mass”, the radically polymerizable PFPE was changed from “compound P14” to “compound P8”, the amount of radically polymerizable PFPE was changed from “20 parts by mass” to “40 parts by mass”, and the amount of metal oxide fine particles was changed from “100 parts by mass” to “120 parts by mass”.

### Example 9: Production of Image Support 9

An image support 9 was produced in the same manner as in the production of the image support 5, except that the radically polymerizable PFPE was changed from “compound P14” to “compound P18”.

### Example 10: Production of Image Support 10

An image support 10 was produced in the same manner as in the production of the image support 1, except that the radically polymerizable monomer was changed from “M2” to “M8”, the amount of radically polymerizable monomer was changed from “100 parts by mass” to “110 parts by mass”, the radically polymerizable PFPE was changed from “compound P10” to “compound P1”, and the amount of radically polymerizable PFPE was changed from “40 parts by mass” to “30 parts by mass”.

### Example 11: Production of Image Support 11

An image support 11 was produced in the same manner as in the production of the image support 1, except that the radically polymerizable PFPE was changed from “compound P10” to “compound P15”.

### Example 12: Production of Image Support 12

An image support 12 was produced in the same manner as in the production of the image support 1, except that the radically polymerizable monomer was changed from “M2” to “M1”, the radically polymerizable PFPE was changed from “compound P10” to “compound P4”, and the metal oxide fine particles were changed from “2” to “1”.

### Example 13: Production of Image Support 13

An image support 13 was produced in the same manner as in the production of the image support 12, except that the radically polymerizable PFPE was changed from “compound P4” to “compound P17”, the metal oxide fine particles were changed from “1” to “2”, and the amount of metal oxide fine particles was changed from “100 parts by mass” to “120 parts by mass”.

### Example 14: Production of Image Support 14

An image support 14 was produced in the same manner as in the production of the image support 12, except that the amount of radically polymerizable monomer was changed from “100 parts by mass” to “110 parts by mass”, the radically polymerizable PFPE was changed from “compound P4” to “compound P11”, the amount of radically polymerizable PFPE was changed from “40 parts by mass” to “30 parts by mass”, and the metal oxide fine particles were changed from “1” to “2”.

### Example 15: Production of Image Support 15

An image support 15 was produced in the same manner as in the production of the image support 12, except that the amount of radically polymerizable monomer was changed from “100 parts by mass” to “90 parts by mass”, the radically polymerizable PFPE was changed from “compound P4” to “compound P10”, and the amount of radically polymerizable PFPE was changed from “40 parts by mass” to “50 parts by mass”.

### Example 16: Production of Image Support 16

An image support 16 was produced in the same manner as in the production of the image support 12, except that the radically polymerizable PFPE was changed from “compound P4” to “compound P20”, the metal oxide fine particles were changed from “1” to “2”, and the amount of metal oxide fine particles was changed from “100 parts by mass” to “120 parts by mass”.

### Example 17: Production of Image Support 17

An image support 17 was produced in the same manner as in the production of the image support 12, except that the radically polymerizable PFPE was changed from “compound P4” to “compound P9”.

### Comparative Example 1: Production of Image Support 18

An image support 18 was produced in the same manner as in the production of the image support 1, except that the radically polymerizable PFPE was changed from “compound P10” to “compound P21”, and the metal oxide fine particles were changed from “2” to “1”.

### Comparative Example 2: Production of Image Support 19

An image support 19 was produced in the same manner as in the production of the image support 1, except that the radically polymerizable PFPE was changed from “compound P10” to “compound P22”.

### Comparative Example 3: Production of Image Support 20

An image support 20 was produced in the same manner as in the production of the image support 1, except that the radically polymerizable monomer was changed from “M2” to “M1”, the amount of radically polymerizable monomer was changed from “100 parts by mass” to “120 parts by mass”, the radically polymerizable PFPE was changed from “compound P10” to “compound P23”, the amount of radically polymerizable PFPE was changed from “40 parts by mass” to “20 parts by mass”, and the amount of metal oxide fine particles was changed from “100 parts by mass” to “120 parts by mass”.

### Comparative Example 4: Production of Image Support 21

An image support 21 was produced in the same manner as in the production of the image support 1, except that the radically polymerizable PFPE was changed from “compound P10” to “compound P25”, and the metal oxide fine particles were changed from “2” to “1”.

### Comparative Example 5: Production of Image Support 22

An image support 22 was produced in the same manner as in the production of the image support 1, except that the amount of radically polymerizable monomer was changed from “100 parts by mass” to “110 parts by mass”, the radically polymerizable PFPE was changed from “compound P10” to “compound P26”, and the amount of radically polymerizable PFPE was changed from “40 parts by mass” to “30 parts by mass”.

The materials of the image supports 1 to 22 are shown in Table 2.

TABLE 2

| | | Radically | | Radically | | Metal oxide | |
|---|---|---|---|---|---|---|---|
| | | polymerizable | | polymerizable | | fine | |
| | | monomer | | PFPE | | particles | |
| | | | Content | | Content | | Content |
| | Image | | (part | | (part | | (part |
| | support | | by | Compound | by | | by |
| | No. | No. | mass) | No. | mass) | No. | mass) |
| Example 1 | 1 | M2 | 100 | P10 | 40 | 2 | 100 |
| Example 2 | 2 | M1 | 100 | P2 | 40 | 1 | 100 |
| Example 3 | 3 | M2 | 120 | P3 | 20 | 2 | 100 |
| Example 4 | 4 | M6 | 110 | P13 | 30 | 2 | 120 |
| Example 5 | 5 | M1 | 120 | P14 | 20 | 2 | 100 |
| Example 6 | 6 | M1 | 90 | P6 | 50 | 1 | 100 |
| Example 7 | 7 | M1 | 100 | P7 | 40 | 1 | 120 |
| Example 8 | 8 | M1 | 100 | P8 | 40 | 2 | 120 |
| Example 9 | 9 | M1 | 120 | P18 | 20 | 2 | 100 |
| Example 10 | 10 | M8 | 110 | P1 | 30 | 2 | 100 |
| Example 11 | 11 | M2 | 100 | P15 | 40 | 2 | 100 |
| Example 12 | 12 | M1 | 100 | P4 | 40 | 1 | 100 |
| Example 13 | 13 | M1 | 100 | P17 | 40 | 2 | 120 |
| Example 14 | 14 | M1 | 110 | P11 | 30 | 2 | 100 |
| Example 15 | 15 | M1 | 90 | P10 | 50 | 1 | 100 |
| Example 16 | 16 | M1 | 100 | P20 | 40 | 2 | 120 |
| Example 17 | 17 | M1 | 100 | P9 | 40 | 1 | 100 |
| Comparative | 18 | M2 | 100 | P21 | 40 | 1 | 100 |
| Example 1 | | | | | | | |
| Comparative | 19 | M2 | 100 | P22 | 40 | 2 | 100 |
| Example 2 | | | | | | | |
| Comparative | 20 | M1 | 120 | P23 | 20 | 2 | 120 |
| Example 3 | | | | | | | |
| Comparative | 21 | M2 | 100 | P25 | 40 | 1 | 100 |
| Example 4 | | | | | | | |
| Comparative | 22 | M2 | 110 | P26 | 30 | 2 | 100 |
| Example 5 | | | | | | | |

[Evaluation]

The image supports 1 to 22 were each mounted on a full-color copying machine (trade name: “bizhub PRO C6501”, manufactured by Konica Minolta Camera Business Technologies; “bizhub” is their registered trademark) and subjected to a durability test, in which 500,000 copies of character images having an image ratio of 6% were continuously printed in A4 landscape mode in a high-humidity, high-temperature environment (HH environment) at 30° C. and 85% RH, without applying a lubricant to the image support.

(1) Wear Resistance

Before and after the durability test, the thickness of a uniform-thickness portion of the image support (the thickness is likely to be non-uniform at each end of an image support, so at least 3 cm from each end is excluded) was measured at ten points at random using an eddy-current film thickness gauge (trade name: “EDDY560C”, manufactured by HELMUT FISCHER GMBTE CO.), and the average was determined as the layer thickness on the image support. Then, the difference in layer thickness before and after the durability test was defined as the amount of wear. A smaller amount of wear indicates higher wear resistance. When the amount of wear is 2.0 μm or less, the resistance is practically satisfactory.

(2) Scratch Resistance

A halftone image was printed on an entire A3 paper, and the scratch resistance of the image support was evaluated according to the following criteria.

⊙: When visually examined, the image support surface has no noticeable scratch. Also in the halftone image, no image defect corresponding to a scratch on the image support is observed (excellent).

◯: When visually examined, the image support surface has minor scratches. However, in the halftone image, no image defect corresponding to a scratch on the image support is observed (practically satisfactory).

x: When visually examined, the image support surface has apparent scratches. Also in the halftone image, image defects corresponding to the scratches are observed (practically unsatisfactory).

(3) Cleanability

During the durability test and after the durability test, the surface of the image support was visually observed, and the cleanability of the image support was evaluated according to the following criteria.

⊙: Passing-through of the toner did not occur during the printing of 500,000 copies; completely satisfactory level.

◯: Passing-through of the toner is partially observed on the image support at the time of the completion of the printing of 500,000 copies, but the output images are excellent; practically satisfactory level.

Δ: Stripe-shaped minor image defects occurred on the output images due to passing-through before the completion of the printing of 500,000 copies; however, practically satisfactory level.

X: Stripe-shaped apparent image defects occurred on the output images due to passing-through before the completion of the printing of 500,000 copies (practically unsatisfactory).

The evaluation results from each image support are shown in Table 3.

TABLE 3

| | | Amount of | | |
|---|---|---|---|---|
| | Image | wear | Scratch | |
| | support No. | (μm) | resistance | Cleanability |
| Example 1 | 1 | 0.5 | ⊙ | ⊙ |
| Example 2 | 2 | 0.9 | ⊙ | ⊙ |
| Example 3 | 3 | 1.2 | ◯ | ◯ |
| Example 4 | 4 | 1.1 | ◯ | ⊙ |
| Example 5 | 5 | 0.5 | ⊙ | ◯ |
| Example 6 | 6 | 1.0 | ⊙ | ⊙ |
| Example 7 | 7 | 0.8 | ⊙ | ⊙ |
| Example 8 | 8 | 0.7 | ⊙ | ⊙ |
| Example 9 | 9 | 0.8 | ⊙ | ◯ |
| Example 10 | 10 | 1.6 | ◯ | ◯ |
| Example 11 | 11 | 0.8 | ⊙ | Δ |
| Example 12 | 12 | 1.1 | ◯ | ◯ |
| Example 13 | 13 | 0.6 | ⊙ | ◯ |
| Example 14 | 14 | 0.8 | ⊙ | ◯ |
| Example 15 | 15 | 1.5 | ◯ | Δ |
| Example 16 | 16 | 1.7 | ◯ | Δ |
| Example 17 | 17 | 0.7 | ◯ | ⊙ |
| Comparative | 18 | 3.3 | X | X |
| Example 1 | | | | |
| Comparative | 19 | 3.0 | X | X |
| Example 2 | | | | |
| Comparative | 20 | 2.6 | X | Δ |
| Example 3 | | | | |
| Comparative | 21 | — | — | — |
| Example 4 | | | | |
| Comparative | 22 | — | — | — |
| Example 5 | | | | |

As shown in Tables 1 to 3, in the image supports 1 to 17, the amount of wear after the durability test is sufficiently small, and they also have sufficient scratch resistance and cleanability. Therefore, it can be seen that an electrophotographic image support including a photosensitive layer and a protective layer laminated in this order on a conductive support, wherein the protective layer is formed of a polymerized cured product of a radically polymerizable composition containing a radically polymerizable monomer and a tetra- or higher functional specific radically polymerizable PFPE, has sufficient cleanability even without using a lubricant or even when the protective layer has been worn.

In contrast, in the image supports 18 to 20, the wear resistance and scratch resistance were insufficient. In particular, in the image supports 18 and 19, the cleanability was also insufficient. This is considered to be because the molecular weight of the organic group connecting the PFPE and the radically polymerizable functional group was too large, whereby the concentrations of the PFPE moiety and the radically polymerized moiety in the protective layer were relatively low.

In addition, in both the image supports 21 and 22, during the application of the coating material for a protective layer, the coating film was repelled, making it impossible to form a protective layer. This is considered to be because the molecular weight of the organic group connecting the PFPE and the radically polymerizable functional group was too small, whereby the liquid repellence of the PFPE was strongly exerted during the application.

According to an embodiment of the present invention, in an electrophotographic image support of an electrophotographic image forming device, the wear resistance, scratch resistance, and cleanability can be enhanced. Therefore, according to an embodiment of the present invention, further improvement in performance, further improvement in durability, and further spread of an electrophotographic image forming device can be expected.

Although the present invention has been described and illustrated in detail, it is clearly understood that the same is by way of illustrated and example only and is not to be taken byway of limitation, the scope of the present invention being interpreted by terms of the appended claims.

What is claimed is:

1. An electrophotographic image support comprising:
a conductive support;
a photosensitive layer disposed on the conductive support; and
a protective layer disposed on the photosensitive layer,
the protective layer being formed of a polymerized cured product of a radically polymerizable composition containing a radically polymerizable monomer and a perfluoropolyether compound having a radically polymerizable functional group,
the perfluoropolyether compound having the radically polymerizable functional group being represented by the following formula (1):
[Chemical Formula 1]
(B)ₗ-A-CF₂O(CF₂CF₂O)ₘ(CF₂O)ₙCF₂-A-(B)ₗ (1)
wherein A represents a linking group having a molecular weight of 100 or more and 400 or less, B represents a radically polymerizable functional group, l represents an integer of 2 or more, and m and n each represent an integer of 0 or more, wherein m+n≧1.

2. The electrophotographic image support according to claim 1, wherein the B is represented by the following formula (2): 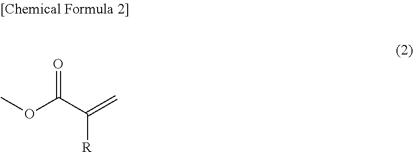
wherein R represents a hydrogen atom or a methyl group.

3. The electrophotographic image support according to claim 1, wherein the radically polymerizable composition further contains metal oxide fine particles having a radically polymerizable functional group.
